(19) United States
(12) Patent Application Publication
(10) Pub. No.: US 2018/0202485 A1
(43) Pub. Date: Jul. 19, 2018

(54) PROP-SHAFT FOR A VEHICLE

(71) Applicant: GM GLOBAL TECHNOLOGY OPERATIONS LLC, Detroit, MI (US)

(72) Inventors: Wallace J. Hill, Commerce Township, MI (US); Mark A. Gehringer, Milford, MI (US); David P. Schankin, Harrison Township, MI (US); Rolando V. Rodriguez, Metamora, MI (US)

(21) Appl. No.: 15/405,814

(22) Filed: Jan. 13, 2017

(51) Int. Cl. F16C 3/02

(52) U.S. Cl. CPC F16C 3/023; B60Y 2300/207; F16C 2326/20; B60Y 2306/09

(57) ABSTRACT

A vehicle, a prop-shaft and a method of reducing noise in a vehicle are provided. The prop-shaft includes a cylindrical shaft having a hollow interior. A liner is positioned within at least a portion of the hollow interior. A first retaining member is disposed adjacent an end of the liner, the first retaining member sized to inhibit movement of the liner in a first direction. A second retaining member is disposed adjacent an opposite end of the liner from the first retaining member, the second retaining member sized to inhibit movement of the liner in a second direction, the second direction being opposite the first direction.

### INTRODUCTION

The subject disclosure relates to a vehicle having a prop-shaft, and more particularly, to a prop-shaft having a shaft liner configured to accommodate or dampen modes of vibration.

Vehicles, such as automobiles and trucks for example, include a rear drive module (RDM) that is connected to the vehicle engine by a prop-shaft. The prop-shaft transmits rotational energy (torque) developed by the vehicle engine to the rear drive module, which in turn transmits the rotational energy to the wheels. In a rear-wheel drive vehicle, the prop-shaft directly couples the RDM to the vehicle's transmission. In an all-wheel or four-wheel drive vehicle, additional components may also be included, such as a power take-off unit for example.

During operation, RDM or PTU gear mesh vibration may be transferred into the prop shaft. Additionally, torque fluctuations created by the meshing of the hypoid gear set in the axle or a power transfer unit are also transmitted through the prop-shaft. In some situations these vibration disturbances may result in undesired interior noises at the driver's ear.

Accordingly, it is desirable to provide a means for damping vibrations in the prop-shaft to reduce or eliminate airborne noise observed at the prop surface and interior of the vehicle.

### SUMMARY

In accordance with an embodiment, a prop-shaft for a vehicle is provided. The prop-shaft includes a cylindrical shaft having a hollow interior. A liner is positioned within at least a portion of the hollow interior. A first retaining member is disposed adjacent an end of the liner, the first retaining member sized to inhibit movement of the liner in a first direction. A second retaining member is disposed adjacent an opposite end of the liner from the first retaining member, the second retaining member sized to inhibit movement of the liner in a second direction, the second direction being opposite the first direction.

In addition to one or more of the features described herein, or as an alternative, further embodiments of the prop-shaft provide that the liner is made from a planar material rolled into a coiled shape.

In addition to one or more of the features described herein, or as an alternative, further embodiments of the prop-shaft provide that the first retaining member and the second retaining member are cylindrical in shape and have a radial thickness that is equal to or larger than a thickness of the liner.

In addition to one or more of the features described herein, or as an alternative, further embodiments of the prop-shaft provide that the first retaining member and the second retaining member have a cylindrical body and an elastomeric member disposed between the cylindrical body and an inner surface of the cylindrical shaft.

In addition to one or more of the features described herein, or as an alternative, further embodiments of the prop-shaft provide that the first retaining member and the second retaining member have a cylindrical body. The cylindrical body includes a retention member that is disposed on a circumference of a surface on its outer diameter.

In addition to one or more of the features described herein, or as an alternative, further embodiments of the prop-shaft provide that the first retaining member is positioned at or adjacent a first anti-node of the cylindrical shaft and the second retaining member is positioned at or adjacent a second anti-node of the cylindrical shaft.

In addition to one or more of the features described herein, or as an alternative, further embodiments of the prop-shaft provide that the first retaining member includes a first internally tuned damper and the second retaining member includes a second internally tuned damper.

In addition to one or more of the features described herein, or as an alternative, further embodiments of the prop-shaft include an insert member that is arranged coaxial with the liner.

In addition to one or more of the features described herein, or as an alternative, further embodiments of the prop-shaft provide that the first retaining member and the second retaining member are sized to couple with the cylindrical shaft by a press-fit.

In accordance with an embodiment, a prop-a vehicle is provided. The vehicle includes an engine and a rear differential. A prop-is shaft is provided that is operably coupled between the engine and the rear differential. The prop-shaft includes a cylindrical shaft having a hollow interior. A liner is positioned within at least a portion of the hollow interior. A first retaining member is disposed adjacent an end of the liner, the first retaining member sized to inhibit movement of the liner in a first direction. A second retaining member is disposed adjacent an opposite end of the liner from the first retaining member, the second retaining member sized to inhibit movement of the liner in a second direction, the second direction being opposite the first direction.

In addition to one or more of the features described herein, or as an alternative, further embodiments of the vehicle provide that the liner is made from a planar material rolled into a coiled shape.

In addition to one or more of the features described herein, or as an alternative, further embodiments of the vehicle provide that the first retaining member and the second retaining member are cylindrical in shape and have a radial thickness that is equal to or larger than a thickness of the liner.

In addition to one or more of the features described herein, or as an alternative, further embodiments of the vehicle provide that the first retaining member and the second retaining member have a cylindrical body and an elastomeric member disposed between the cylindrical body and an inner surface of the cylindrical shaft.

In addition to one or more of the features described herein, or as an alternative, further embodiments of the vehicle provide that the first retaining member and the second retaining member have a cylindrical body. The cylindrical body includes a retention member disposed on a circumference of a surface on its outer diameter.

In addition to one or more of the features described herein, or as an alternative, further embodiments of the vehicle provide that the first retaining member is positioned at or adjacent a first anti-node of the cylindrical shaft and the second retaining member is positioned at or adjacent a second anti-node of the cylindrical shaft.

In addition to one or more of the features described herein, or as an alternative, further embodiments of the vehicle provide that the first retaining member includes a first internally tuned damper and the second retaining member includes a second internally tuned damper.

In addition to one or more of the features described herein, or as an alternative, further embodiments of the vehicle include an insert member that is arranged coaxial with the liner.

In addition to one or more of the features described herein, or as an alternative, further embodiments of the vehicle provide that the first retaining member and the second retaining member are sized to couple with the cylindrical shaft by a press-fit.

In accordance with another embodiment, a method of reducing noise in a vehicle is provided. The method includes identifying a location of a first anti-node and a location of a second anti-node of a prop-shaft that operably couples an engine to a rear differential, the prop-shaft having a hollow interior. A liner is positioned between the location first anti-node and the location of the second anti-node. The liner is retained in a first direction with a first member. The liner is retained in a second direction with a second member, the second direction being opposite the first direction.

In addition to one or more of the features described herein, or as an alternative, further embodiments of the method provide that the first member is press-fit into the hollow interior adjacent a first end of the liner and the second member is press-fit into the hollow interior adjacent the second member.

In addition to one or more of the features described herein, or as an alternative, further embodiments of the method further include dampening torsional vibrations with a first internal torsional damper coupled to an interior diameter of the first member and a second internal torsional damper coupled to an interior diameter of the second member.

In addition to one or more of the features described herein, or as an alternative, further embodiments of the method further include forming the liner from a planar sheet and rolling into a coil, the first member and the second member having a radial thickness that is equal to or greater than the radial thickness of the coil.

The above features and advantages and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic plan view of a vehicle having a prop-shaft in accordance with an embodiment;

FIG. 2 is a schematic illustration of the prop-shaft of FIG. 1 with bending vibration modes superimposed thereon;

FIG. 3 is a schematic illustration of the prop-shaft of FIG. 1 with a shell vibration mode superimposed thereon;

FIG. 4 is a partial perspective view of the prop-shaft of FIG. 1 in accordance with an embodiment;

FIG. 5 is a partial perspective view of the prop-shaft of FIG. 1 in accordance with another embodiment;

FIG. 6 is a sectional view of the prop-shaft of FIG. 4 in accordance with an embodiment;

FIG. 7 is a partial disassembled view of the prop-shaft of FIG. 1 in accordance with another embodiment;

FIG. 8 is a sectional view through the insert member of the prop-shaft of FIG. 7 in accordance with an embodiment; and

FIG. 9 and FIG. 10 are schematic illustrations of the prop-shaft of FIG. 1 showing a positioning of a liner and retainer assembly with respect to vibration modes of the prop-shaft.

### DETAILED DESCRIPTION

The following description is merely exemplary in nature and is not intended to limit the present disclosure, its application or uses.

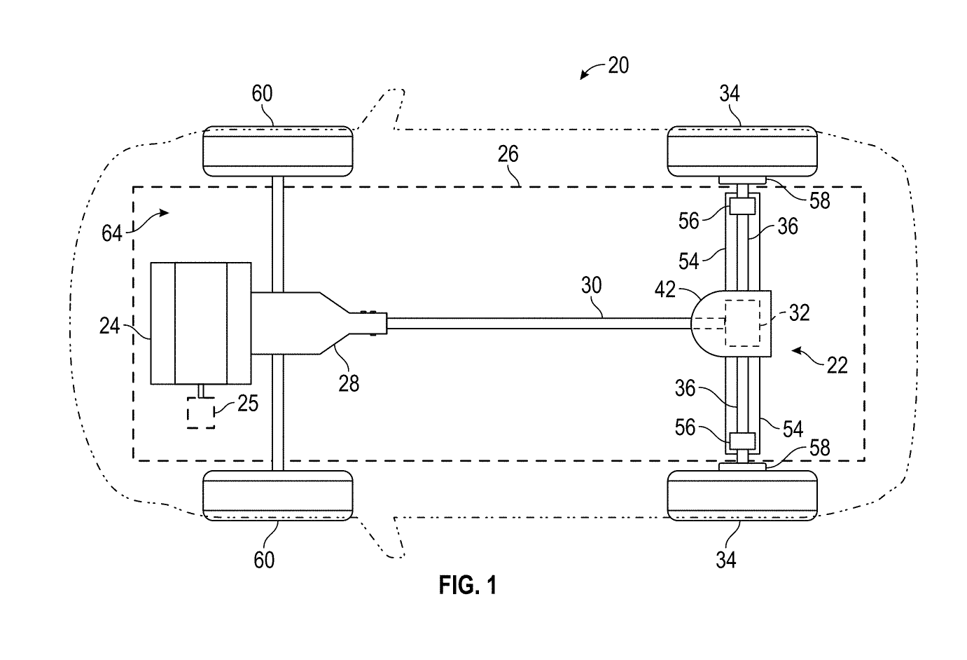

In accordance with an embodiment, FIG. 1 illustrates a vehicle 20 having a front axle assembly 64 and rear drive module (RDM) 22. It should be appreciated that the vehicle 20 may be an automobile or a truck for example. The vehicle 20 may include an engine 24, such as a gasoline or diesel fueled internal combustion engine. The engine 24 may further be a hybrid type engine that combines an internal combustion engine with an electric motor for example. In one embodiment, the vehicle 20 includes a controller or engine control module 25 that provides control functionality to one or more components of the vehicle, such as but not limited to the engine 24.

The engine 24 and RDM 22 are coupled to a vehicle structure such as a chassis or frame 26. The engine 24 is coupled to the RDM 22 by a transmission, transfer case or coupling 28 and a prop-shaft 30. The transmission 28 may be configured to reduce the rotational velocity and increase the torque of the engine output. This modified output is then transmitted to the RDM 22 via the prop-shaft 30. The RDM 22 transmits the output torque from the prop-shaft 30 to a pair of driven-wheels 34 via axles 36 and wheel flanges 58. In an embodiment, the prop-shaft 30 may be disposed within a housing, such as a torque tube.

In one embodiment, the RDM 22 includes the differential housing 42, which supports a hypoid gear set 32. As used herein, the hypoid gear set 32 includes a ring gear, a pinion shaft/gear and a differential case. The differential case may include a differential gear set assembly as is known in the art for transmitting torque from the ring gear to the axles. In one embodiment, a pair of axle tubes 54 is coupled to and extends from the housing 42. One or more wheel bearings 56 may be disposed at an end of the axle tubes 54 distal from the differential housing 42 to support the axles 36. It should be appreciated that in other embodiments, the RDM 22 may have other configurations than a hypoid gear set.

The vehicle 20 further includes a second set of wheels 60 arranged adjacent the engine 24. In one embodiment, the second set of wheels 60 is also configured to receive output from the engine 24. This is sometimes referred to as a four-wheel or an all-wheel drive configuration.

As used herein, the term “front” refers to a position that is generally closer to the engine 24 or the front of the vehicle 20, while the term “rear” refers to a position that is closer to the axle 36 or the rear end of the vehicle 20.

In an embodiment, the prop-shaft 30 has a cylindrical body with a hollow interior. The cylindrical body may be made from aluminum or steel. It should be appreciated that vibrations from the engine 24, transmission 28, RDM 22, or a power transfer unit (PTU) may be transferred along the prop-shaft 30. It should be appreciated that the sources of the vibration provided herein are exemplary in nature and the claims are not bound to or limited by any theory on the vibration source. Regardless of the source, these vibrations may create noise that is heard by the vehicle operator. The vibrations may also be transmitted to the frame or chassis 26 and felt by the operator. In embodiments where the prop-shaft 30 is made from aluminum, these vibrations may be amplified, relative to a shaft made from steel, since aluminum has a higher transmission efficiency and lower mass damping. However, aluminum prop-shafts provide advantages for larger diameter prop-shafts due to their decreased weight. It should be appreciated that these transmitted vibrations and sounds may be undesired by the operator.

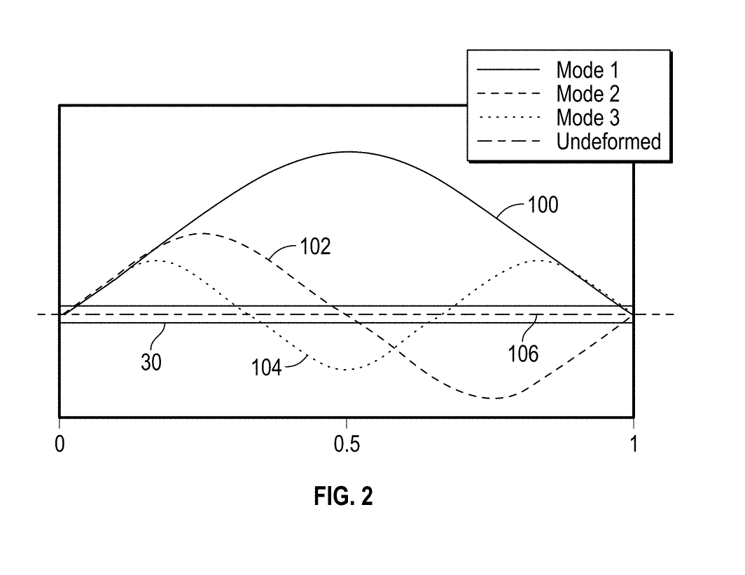

The vibration of a body, such as a hollow cylinder for example, causes the body to form the vibration shape is based on the vibration mode. A vibration mode is particular to the shape and material of the body. Referring now to FIG. 2, the un-deformed prop-shaft 30 is shown with three different vibration bending modes 100, 102, 104 superimposed thereon. Each of the modes has a generally wavelike shape with nodes being positioned at the location where the particular mode crosses the centerline 106 of the undeformed shaft. Correspondingly, each mode also has an anti-node, which is defined as the location of maximum amplitude of the vibration shape. It should be appreciated that while the embodiment of FIG. 2 illustrates the mode shapes in two dimensions, this is for illustrative purposes. It should be appreciated that the shapes of vibration modes 100, 102, 104 illustrated in FIG. 2 represent one-half of the shape for each mode since the body will oscillate between the illustrated shape and a mirror image of the shape on the opposite side of the centerline 106. Further, it should be appreciated that vibration modes may also have three-dimensional waveforms.

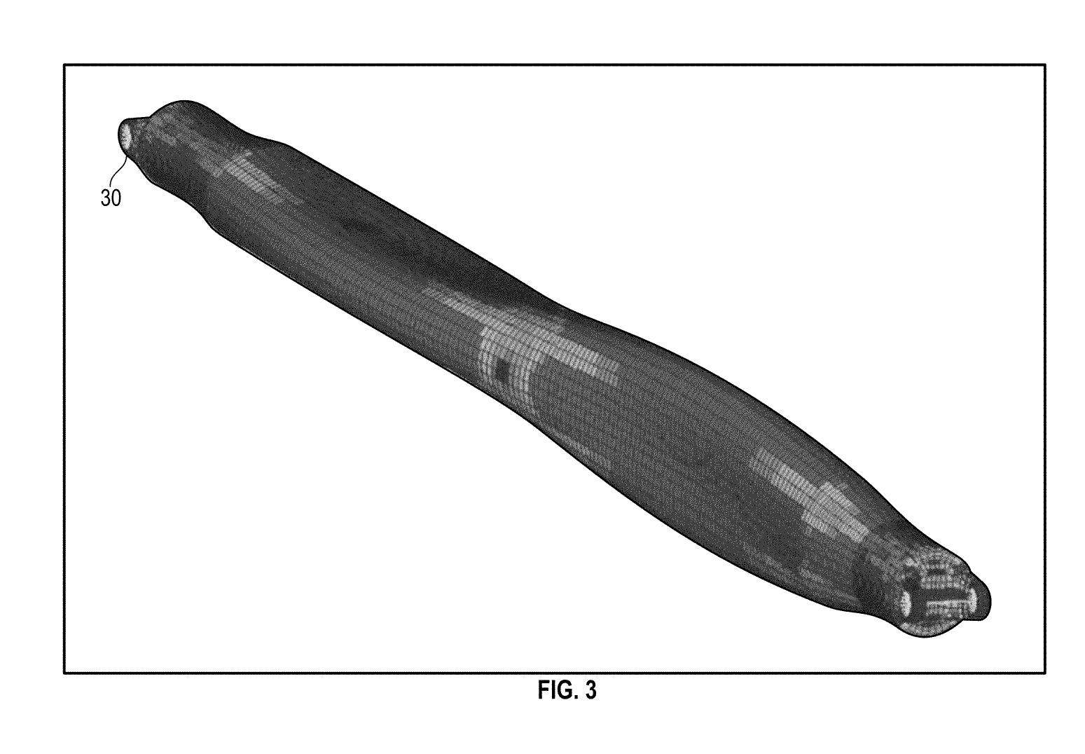

The shaft 30 may have vibratory modes in addition to the bending modes illustrated in FIG. 2, such as bending or torsional vibration modes. Referring now to FIG. 3, an example of a 2nd shell mode is illustrated. While only the 2^{nd} shell mode is illustrated, the shaft 30 may also have additional shell modes (1^{st}, 3^{rd}, etc.). It should be appreciated that while some embodiments herein describe the modification of the vibration modes with respect to a bending mode, this is for exemplary purposes and the disclosure should not be so limited. The arrangement of the prop-shaft assembly disclosed herein may be used to affect any of the vibration modes (e.g. bending, shell, torsion).

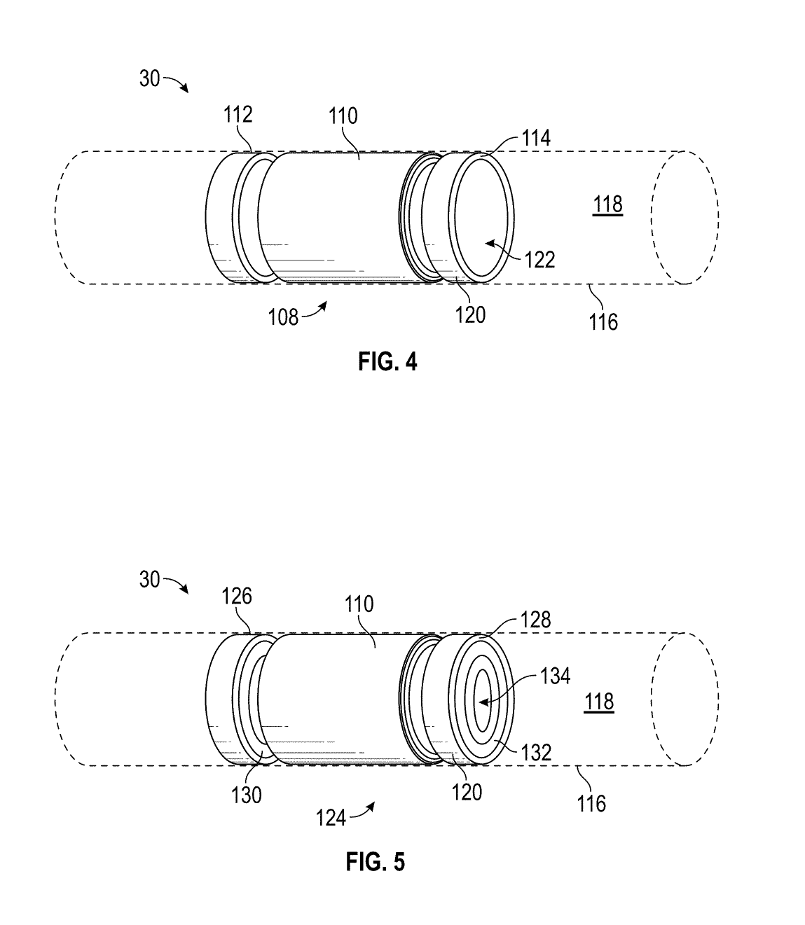

It should also be appreciated that some vibration modes may create transmitted noise or vibration that is less desirable than other modes. This may depend on the input vibrations from the transmission 28 and RDM 22 for example. Thus, for a given vehicle, the prop-shaft assembly may be configured to affect one or more vibration modes. Turning now to FIG. 4 a prop-shaft 30 is shown having a vibration dampening assembly 108. The prop-shaft 30 includes a cylindrical shaft body 116 having a wall that defines a hollow interior area 118. In an embodiment, the assembly 108 includes a liner 110, a first retaining member 112 and a second retaining member 114. The liner 110 may be formed from a planar or sheet material that is rolled into a coil before being inserted into the hollow interior 118 of shaft body 116. In an embodiment, the liner 110 may be formed from a cardboard, corrugated paper, paperboard or other fibrous material for example.

It should be appreciated that if the liner 110 is simply inserted into the hollow interior portion, there is a risk that the liner 110 will unroll or the individual layers of the coil may laterally displace relative to each other over time. As a result, in some instances, balance issues may arise with the prop-shaft during operation. To prevent or reduce this risk, the retaining members 112, 114 are coupled to the shaft body 116 adjacent opposing ends of the liner 110. The retaining members 112, 114 inhibit movement of the liner 110 and maintain the liner 110 in the desired position along the length of the shaft body 116. In an embodiment, the retaining members 112, 114 are spaced apart from the ends of the liner 110. In another embodiment, the retaining members 112, 114 are in contact with the liner 110.

In the embodiment of FIG. 4, the retaining members 112 114, have an outer surface 120 that is sized to fit within the hollow interior 118. In an embodiment, the retaining members are coupled to the shaft body 116 by a press-fit. In an embodiment, the outer surface 120 is formed from a layer of an elastomer material or has features (e.g. a star configuration) that in-part define the hoop or ring stiffness of the retaining members 112, 114. By adjusting the hoop/ring stiffness, the vibration shell modes of the prop-shaft 30 may be dampened. In the illustrated embodiment, the retaining members 112, 114 are in the form of a ring having a hollow inner diameter 122. The radial wall thickness of the ring is sized equal to or larger than the radial thickness of the liner 110. In this way, the side wall of the retaining member maintains the balance of the prop-shaft 30 by preventing or reducing the risk of significant lateral displacement of the coiled liner layers. In an embodiment, the retaining members 112, 114 are made from aluminum.

Referring now to FIG. 5, another embodiment is shown of the vibration dampening assembly 124. This embodiment is similar to that of FIG. 4 in that a liner 110 formed from a coiled planar material is inserted into the hollow interior 118 of the shaft body 116. In this embodiment, the liner 110 is retained laterally by retaining members 126, 128. The retaining members 126, 128 have a ring shape similar to retaining members 112, 114 described with respect to FIG. 4. In this embodiment, each of the retaining members 126, 128 includes an elastomer ring 130, 132 coupled to the inner diameter of the ring shaped body. The rings 130, 132 are an internally tuned damper (ITD) that allows damping of vibrations by changing the radial stiffness of the retaining members 126, 128. The interior of the rings 130, 132 may be a hollow interior area 134 or may be filled with a solid mass depending on the desired radial stiffness.

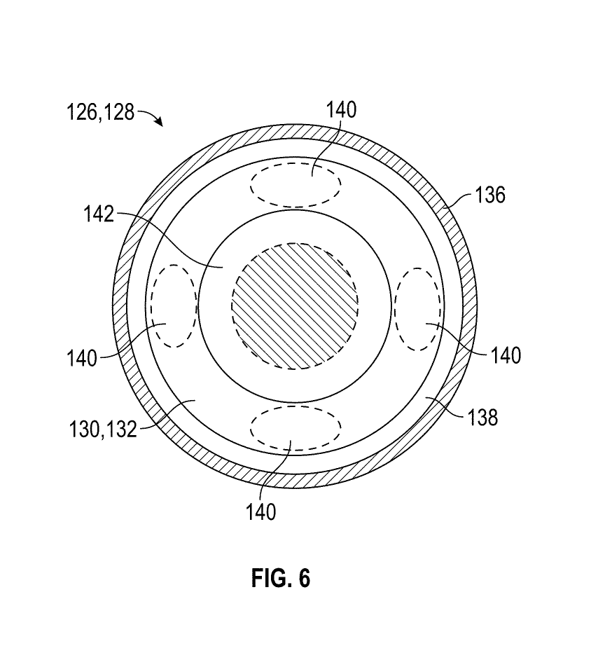

In the embodiment shown in FIG. 6, the retaining members 126, 128 have an outer ring 136. The outer ring 136 may be formed from an elastomeric material. The inner diameter of the outer ring 136 is coupled to a ring body 138. The ring body 138 may be formed from suitable material such as aluminum or steel. Coupled to the inner diameter of the ring body 138 is the ITD ring 130, 132. In an embodiment, the ITD ring 130, 132 may have voids or solid material 140 embedded in the elastomeric material. It should be appreciated that these voids/solid-material-members 140 may be sized/shaped to change the radial stiffness of the ITD ring 130, 132. In an embodiment the voids/solid-material-members 140 are distributed equidistant about the circumference of the ITD ring 130, 132. As discussed herein with reference to FIG. 4, a solid member 142 may be positioned radially inward from the ITD ring 130, 132 depending on the amount of radial stiffness that is desired.

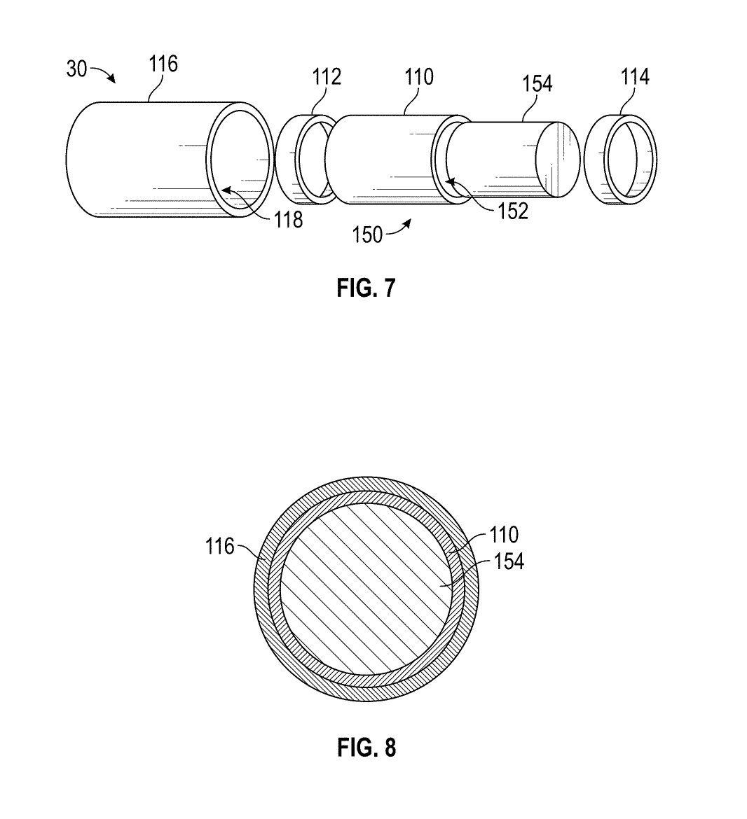

Referring now to FIG. 7 and FIG. 8, another embodiment is shown of the vibration dampening assembly 150. In this embodiment, the liner 110 is inserted into the hollow interior 118 of the shaft body 116. The inner surface of liner 110 defines a space 152 that is sized to receive an insert member 154. The insert member 154 may be sized to have a length that is substantially the same as the liner 110. In the exemplary embodiment, the insert member 154 may be made from an open-cell or a closed-cell foam material having a cylindrical shape. During assembly, the liner 110 may be inserted into the shaft body 116 to the desired location and allowed to unroll against the inside surface of the shaft body 116. The insert member 154 is then inserted into the space 152. It should be appreciated that the insert member 154 restrains the liner 110. In an embodiment, the insert member applies a radial force on the liner 110 that is sufficient to retain the liner 110 in position while maintaining the damping benefit of the air gaps between the layers of paper. In an embodiment, the vibration dampening assembly 150 may further include retaining members 112, 114 that are disposed at the ends of the liner 110 and insert member 154. In another embodiment, the liner 110 may be retained by an adhesive strip on the leading edge of the liner 110. The adhesive strip is small enough so that the liner 110 can roll/unroll against the inside of the shaft body 116 but not displace along the length of the shaft body 116.

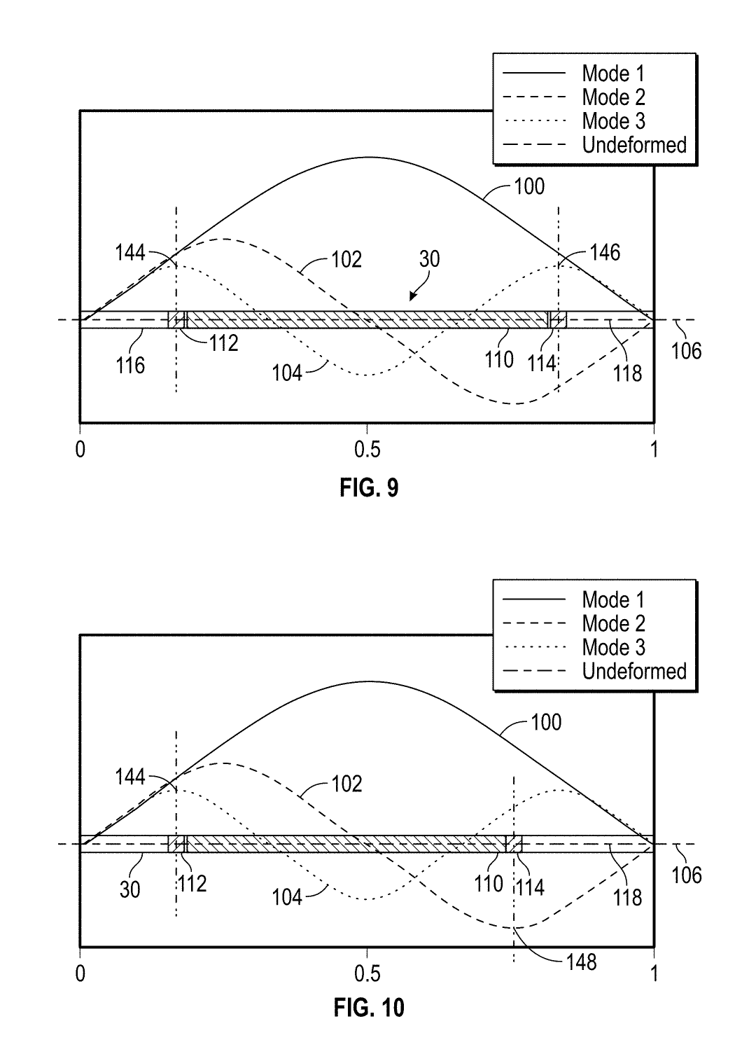

Referring now to FIG. 9, the positioning of the vibration damping assembly will be described. As discussed herein above, in a natural state (e.g. undamped state) the prop-shaft 30 will have a number of vibratory modes, such as bending modes 100, 102, 104 for example, that are a function of the shaft body 116 diameter and the material of which it is made. It is desirable to dampen these modes, or at least some of these modes to avoid transmitting undesired noise or vibration frequencies. The first step in this process is to identify the modes 100, 102, 103. In the illustrated embodiment, it is desirable to dampen the third mode 104. Once the shape of the waveform of the third mode 104 is determined, the positions of the anti-nodes 144, 146 of the third mode 104 are also known.

With the anti-nodes 144, 146 identified, the liner 110 is sized to fit between the anti-nodes 144, 146 and is inserted into the shaft body 116. The retaining members 112, 114 are inserted into the hollow interior 118 (such as by a press-fit for example) to retain the liner 110 in the location between the anti-nodes 144, 146. In an embodiment, the liner 110 is sized such that the middle of the retaining members 112, 114 is centered on the respective anti-nodes 144, 146. In another embodiment, the retaining members 126, 128 may also be used to provide additional damping (such as to provide damping of vibration shell modes for example). It should be appreciated that by arranging the liner 110 and retaining members 112, 114 in this position, the vibratory response of the prop-shaft 30 will be changed from its natural or undamped state and the third mode 104 will be dampened.

It should further be appreciated that in some embodiments, it may be desirable to dampen more than one mode of the prop-shaft 30. Referring now to FIG. 10, another method of positioning of the vibration damping assembly will be described. In this embodiment, it may be desirable to dampen both the second mode 102 and the third mode 104. First the waveforms of the modes 100, 102, 104 are determined and the anti-nodes 144, 148 are identified for the third mode and the second mode respectively. As before, the liner 110 is then sized to the desired length. In this embodiment, the length of the liner is made to fit between the anti-node 144 (of third mode 104) and the anti-node 148 (of second mode 102). The retention members 112, 114 are then inserted into the hollow interior 118 to retain the liner 110 in this position. In an embodiment, the liner 110 is sized to allow the middle of each retention member 112, 114 to be centered on the anti-nodes 144, 148 respectively. It should be appreciated that positioning of the vibration damping assembly in this location will change and dampen the second mode and third mode in the prop-shaft 30.

Some embodiments described herein provide advantages in damping of vibration modes in a prop-shaft of a vehicle using a coiled liner that is retained in a desired location. Some embodiments described herein provide advantages in using a vibration damping assembly in a prop-shaft to selectively dampen predetermined vibration modes. Still further embodiments described herein provide advantages in using a vibration damping assembly in a prop-shaft to selectively dampen multiple predetermined vibration modes.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the invention not be limited to the particular embodiments disclosed, but will include all embodiments falling within the scope of the application.

What is claimed is:

1. A prop-shaft for a vehicle comprising:
a cylindrical shaft having a hollow interior;
a liner positioned within at least a portion of the hollow interior;
a first retaining member disposed adjacent an end of the liner, the first retaining member sized to inhibit movement of the liner in a first direction; and
a second retaining member disposed adjacent an opposite end of the liner from the first retaining member, the second retaining member sized to inhibit movement of the liner in a second direction, the second direction being opposite the first direction.

2. The prop-shaft of claim 1, wherein the liner is made from a planar material rolled into a coiled shape.

3. The prop-shaft of claim 1, wherein the first retaining member and the second retaining member are cylindrical in shape and have a radial thickness that is equal to or larger than a thickness of the liner.

4. The prop-shaft of claim 3, wherein the first retaining member and the second retaining member have a cylindrical body and an elastomeric member disposed between the cylindrical body and an inner surface of the cylindrical shaft.

5. The prop-shaft of claim 3, wherein the first retaining member and the second retaining member have a cylindrical body having a retention member disposed on a circumference of a surface on an outer diameter of the cylindrical body.

6. The prop-shaft of claim 1, wherein the first retaining member is positioned at or adjacent a first anti-node of the cylindrical shaft and the second retaining member is positioned at or adjacent a second anti-node of the cylindrical shaft.

7. The prop-shaft of claim 1, wherein the first retaining member includes a first internally tuned damper and the second retaining member includes a second internally tuned damper.

8. The prop-shaft of claim 1, further comprising an insert member arranged coaxial with the liner.

9. A vehicle comprising:
an engine;
a rear differential; and
a prop-shaft operably coupled between the engine and the rear differential, the prop-shaft including:
a cylindrical shaft having a hollow interior;
a liner positioned within at least a portion of the hollow interior;
a first retaining member disposed adjacent an end of the liner, the first retaining member sized to inhibit movement of the liner in a first direction; and
a second retaining member disposed adjacent an opposite end of the liner from the first retaining member, the second retaining member sized to inhibit movement of the liner in a second direction, the second direction being opposite the first direction.

10. The vehicle of claim 9, wherein the liner is made from a planar material rolled into a coiled shape.

11. The vehicle of claim 9, wherein the first retaining member and the second retaining member are cylindrical in shape and have a radial thickness that is equal to or larger than a thickness of the liner.

12. The vehicle of claim 11, wherein the first retaining member and the second retaining member have a cylindrical body and an elastomeric member disposed between the cylindrical body and an inner surface of the cylindrical shaft.

13. The vehicle of claim 11, wherein the first retaining member and the second retaining member have a cylindrical body having a retention member disposed on a circumference of a surface on an outer diameter of the cylindrical body.

14. The vehicle of claim 9, wherein the first retaining member is positioned at or adjacent a first anti-node of the cylindrical shaft and the second retaining member is positioned at or adjacent a second anti-node of the cylindrical shaft.

15. The vehicle of claim 9, wherein the first retaining member includes a first internally tuned damper and the second retaining member includes a second internally tuned damper.

16. The vehicle of claim 9, further comprising an insert member arranged coaxial with the liner.

17. A method of reducing noise in a vehicle, the method comprising:
identifying a location of a first anti-node and a location of a second anti-node of a prop-shaft that operably couples an engine to a rear differential, the prop-shaft having a hollow interior;
positioning a liner between the location of the first anti-node and the location of the second anti-node;
retaining the liner in a first direction with a first member; and
retaining the liner in a second direction with a second member, the second direction being opposite the first direction.

18. The method of claim 17, wherein the first member is press-fit into the hollow interior adjacent a first end of the liner and the second member is press-fit into the hollow interior adjacent the second member.

19. The method of claim 18, further comprising dampening torsional vibrations with a first internal torsional damper coupled to an interior diameter of the first member and a second internal torsional damper coupled to an interior diameter of the second member.

20. The method of claim 17, further comprising forming the liner from a planar sheet and rolling into a coil, the first member and the second member having a radial thickness that is equal to or greater than the radial thickness of the coil.
